(19) United States
(12) Patent Application Publication
(10) Pub. No.: US 2024/0290538 A1
(43) Pub. Date: Aug. 29, 2024

(54) METHOD OF INCREASING ANISOTROPY OF MAGNETIC MATERIALS

(71) Applicants: UT-Battelle, LLC, Oak Ridge, TN (US); Iowa State University Research Foundation, Inc., Ames, IA (US)

(72) Inventors: Michael S. Kesler, Oak Ridge, TN (US); Michael A. Mcguire, Oak Ridge, TN (US); Zack Tener, Oak Ridge, TN (US); Matthew J. Kramer, Swoope, VA (US); Xubo Liu, Ames, IA (US); Cajetan Ikenna Nlebedim, Ames, IA (US)

(21) Appl. No.: 18/585,633

(22) Filed: Feb. 23, 2024

Related U.S. Application Data
(60) Provisional application No. 63/447,973, filed on Feb. 24, 2023.

(51) Int. Cl. H01F 41/02; B22F 9/02; B22F 9/04; H01F 1/057

(52) U.S. Cl. CPC H01F 41/0273; B22F 9/023; B22F 9/04; H01F 1/0573; B22F 2201/10; B22F 2202/05

(57) ABSTRACT

A method of increasing anisotropy of magnetic materials formed by a hydrogenation-disproportionation-desorption-recombination (HDDR) process is provided. The method includes subjecting a starting magnetic material to a hydrogenation-disproportionation (HD) step in the presence of a magnetic field to obtain intermediate materials. The strength of the applied magnetic field is between 0.25 T and 9 T, optionally less than or equal to 2 T. The HD step may be performed for a period of time between 10 and 60 minutes at a temperature of at least 600° C., optionally in the range of 600° C. to 900° C. Subsequently, the intermediate materials are subjected to a desorption-recombination (DR) step to obtain a magnetic powder. Application of the magnetic field during the hydrogenation-disproportionation step increases the magnetic anisotropy of the obtained magnetic powder. Magnetic powders obtained by the method and bonded magnets formed with the magnetic powders are also provided.

### CROSS-REFERENCE TO RELATED APPLICATIONS

This application claims the benefit of U.S. Provisional Application No. 63/447,973, filed Feb. 24, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 and Contract No. DE-AC02-07CH11358 awarded by the U.S. Department of Energy. The government has certain rights in the invention.

### FIELD OF THE INVENTION

The present invention relates to magnetic materials, and more particularly to hydrogenation-disproportionation-desorption-recombination (HDDR) processes for making magnetic materials.

### BACKGROUND OF THE INVENTION

The Nd₂Fe₁₄B permanent magnet family and their analogues (generally Nd—Fe—B-based magnets) are currently considered to be the hard magnetic materials of choice based on their coercivity and remanence at ambient temperatures. These magnets are used in applications varying from hard disk drives to wind turbines to electric motors, the latter of which is used in many industrial applications including electric vehicles. Nd—Fe—B magnets These magnets have two industrially viable forms, specifically “sintered” and “bonded” varieties. Sintered magnets are manufactured using a very specific, often proprietary, process where the cast magnetic material is pulverized, milled to a small size, aligned in a magnetic field, and then sintered (heated) and compressed into a solid to obtain its final shape. Post-processing, machining, and coating are then performed before magnetizing the material. Bonded magnets also use pulverized feedstock, but rather than sintering, the powder is mixed and cast in a matrix (polymer, resin, etc.) determined by a given application.

Sintered magnets are currently superior to bonded magnets in many of the relevant magnetic properties, including magnetic saturation, coercivity, maximum energy product, and anisotropy. However, sintered Nd—Fe—B magnets do have several drawbacks. One of these is their optimization for anisotropy (Shape and orientation dependence). Sintered Nd—Fe—B magnets are highly optimized for their particular uses, which often limits options for reusability once those uses are expended or require updating. Bonded magnets are comparably cheaper than sintered magnets due to several factors, including lower rare-earth concentration by volume, longer lifetimes due to reuse and recycling pathways, and fewer steps in production.

Processing improvements are needed to fill a middle ground between sintered and current state of the art bonded magnets by maximizing the potential energy product of the latter. Much of the powdered magnetic material utilized in anisotropic Nd—Fe—B bonded magnets is produced through a “hydrogen-disproportionation-desorption-recombination” (HDDR) method. Optimization of this method towards raising the properties of the resultant powders is currently an area in need of improvement, to fill the high demand for powdered magnetic materials that meet economic and technological requirements.

### SUMMARY OF THE INVENTION

A method of increasing anisotropy of magnetic materials formed by an improved hydrogenation-disproportionation-desorption-recombination (HDDR) process is provided. The method includes providing a starting magnetic material. The starting magnetic material is subjected to a hydrogenation-disproportionation (HD) step in the presence of a magnetic field to obtain intermediate materials. Subsequently, the intermediate materials are subjected to a desorption-recombination (DR) step to obtain a magnetic powder. Application of the magnetic field during the hydrogenation-disproportionation step increases the magnetic anisotropy of the obtained magnetic powder.

In specific embodiments, the strength of the applied magnetic field is between 0.25 T and 9 T.

In particular embodiments, the strength of the applied magnetic field is less than or equal to 2 T.

In specific embodiments, the hydrogenation-disproportionation step is performed for a period of time between approximately 10 and 60 minutes.

In specific embodiments, the hydrogenation-disproportionation step includes heating the starting magnetic material to a temperature of at least 600° C. in the presence of hydrogen gas.

In particular embodiments, the temperature is in a range of 600° C. to 900° C.

In specific embodiments, the magnetic field is also applied during the desorption-recombination step.

In specific embodiments, the starting magnetic material is a compound including a rare earth metal component (RE), a transition metal component (TM), and may or may not include a third, nonmetal component (X) such as boron or nitrogen. The starting magnetic material may include one of the following chemical compositions: (RE)₂(TM)₁₄X; (RE)(TM)₅; (RE)₂(TM)₁₇; (RE)₅(TM)₁₇; (RE)(TM)₂; (RE)(TM)₃; (RE)₆(TM)₂₃; (RE)₂(TM)₇; (RE)₅(TM)₁₉; (RE)(TM)₁₂; (RE)₃(TM)₂₇; (RE)(TM)₄X; (RE)(TM)₁₂X₆; (RE)₂(TM)₂₃X₃; (RE)₅(TM)₉X; (RE)₂(TM)₅X₂; (RE)₂(TM)₇X₃; (RE)₂(TM)₁₇X₃; (RE)₃(TM)₁₁X₄; (RE)₃(TM)₁₃X₂, (RE)₅(TM)₁₉X₆.

In other embodiments, a method of increasing anisotropy of magnetic materials formed by a hydrogenation-disproportionation-desorption-recombination (HDDR) process includes disposing the starting magnetic material in an inert atmosphere. The starting magnetic material is subjected to a hydrogenation-disproportionation (HD) step in the presence of an applied static magnetic field. The hydrogenation-disproportionation step includes heating the starting magnetic material to a first temperature and introducing a concentration of hydrogen gas to the starting magnetic material for a first period of time to obtain intermediate materials. Subsequently, the intermediate materials are subjected to a desorption-recombination (DR) step that includes purging the hydrogen gas, heating the intermediate materials to a second temperature under vacuum, maintaining the second temperature for a second period of time under vacuum to obtain a magnetic powder, and allowing the magnetic powder to cool. Application of the static magnetic field during the hydrogenation-disproportionation step increases the magnetic anisotropy of the obtained magnetic powder.

In specific embodiments, the strength of the applied magnetic field is between 0.25 T and 9 T.

In particularly embodiments, the strength of the applied magnetic field is less than or equal to 2 T.

In specific embodiments, the desorption-recombination step further includes applying the static magnetic field.

In specific embodiments, the first temperature is in a range of 700° C. to 900° C.

In specific embodiments, the first period of time is in a range of 10 to 60 minutes.

In specific embodiments, the second temperature is approximately equal to or greater than the first temperature.

In specific embodiments, the second period of time is at least 30 minutes.

In specific embodiments, prior to the desorption-recombination step, the intermediate materials obtained in the hydrogenation-disproportionation step are cooled to ambient temperature.

In specific embodiments, the starting magnetic material is a compound including a rare earth metal component (RE), a transition metal component (TM), and may or may not include a third, nonmetal component (X) such as boron or nitrogen. The starting magnetic material may include one of the following chemical compositions: (RE)₂(TM)₁₄X; (RE)(TM)₅; (RE)₂(TM)₁₇; (RE)₅(TM)₁₇; (RE)(TM)₂; (RE)(TM)₃; (RE)₆(TM)₂₃; (RE)₂(TM)₇; (RE)₅(TM)₁₉; (RE)(TM)₁₂; (RE)₃(TM)₂₇; (RE)(TM)₄X; (RE)(TM)₁₂X₆; (RE)₂(TM)₂₃X₃; (RE)₅(TM)₉X; (RE)₂(TM)₅X₂; (RE)₂(TM)₇X₃; (RE)₂(TM)₁₇X₃; (RE)₃(TM)₁₁X₄; (RE)₃(TM)₁₃X₂, (RE)₅(TM)₁₉X₆.

In specific embodiments, the starting magnetic material is a compound including both a rare earth metal component (RE) and a transition metal component (TM), the starting magnetic material having the chemical formula Nd₂₋ₓ(RE)ₓFe_{14-y}(TM)_{y}B, wherein: RE is one of La, Ce, Pr, Sm, Gd, Tb, Dy, Ho, Er, Tm, Yb, Lu, Th, and Y; TM is one of Fe and Co; 0≤x≤2; and 0≤y≤14.

In particular embodiments, the starting magnetic material includes Nd₂Fe₁₄B.

Magnetic powders obtained by the method are also provided. Additionally, magnets formed with the magnetic powders are provided. The magnets may be bonded magnets, sintered magnets, or powder-in-tube magnets.

These and other features of the invention will be more fully understood and appreciated by reference to the description of the embodiments and the drawings.

### BRIEF DESCRIPTION OF THE DRAWINGS

FIG. 1A is a front, schematic view of a reaction vessel for a hydrogenation-disproportionation-desorption-recombination (HDDR) process in accordance with embodiments of the disclosure;

FIG. 1B is a top, sectional view of the reaction vessel of FIG. 1A;

FIG. 2 is a schematic view of an apparatus for the HDDR process, including the reaction vessel;

FIG. 3A is a graph of a heating profile for a sample in the HDDR process;

FIG. 3B is an enlarged portion of the graph of FIG. 3B showing the DR step of the HDDR process;

FIG. 4 are graphs comparing magnetic properties for a test sample obtained from the HDDR process with no magnetic field applied during the process (0 T, control) and with a test sample obtained from the HDDR process using a magnetic field (2 T, example); and

FIG. 5 is a graph of aligned M vs. H curves normalized to Mₛₐₜ values for the test samples.

### DETAILED DESCRIPTION OF THE CURRENT EMBODIMENTS

As discussed herein, the current embodiments relate to a method of increasing the anisotropy of magnetic powders, such as magnetic powders for use in forming bonded magnets. More particularly, the method is a hydrogenation-disproportionation-desorption-recombination (hereinafter “HDDR” or “HD-DR”) process that generally includes two main steps: a hydrogenation-disproportionation step (hereinafter “HD step”) and a desorption-recombination step (hereinafter “DR step”). In the HD step, the magnetic material (for example, a rare-earth, transition metal intermetallic) is subjected to a targeted high temperature (such as >630° C.) in an otherwise inert atmosphere containing a controlled concentration of hydrogen as a reducing agent. The hydrogen intercalates into the material (“hydrogenation”) then reacts with the rare earth in the rare-earth magnet phase and rare earth rich-grain boundary phases, resulting in hydrides and other binary and elemental products (“disproportionation”). This has a simultaneous volumetric effect on the unit cells of the phases involved, such that the average grain size is reduced significantly compared to the original state. After a specified dwell time, the DR step begins. In the DR step, the hydrogen-containing atmosphere is removed via a vacuum pump or via flushing with a noble gas (“desorption”) while the material is heated, either to the same temperature as in the HD step or a different temperature. The heat treatment causes the aforementioned elemental, binary, and hydride phases to recombine into the target phase, albeit with altered microstructural characteristics (“recombination”). The present HDDR method improves the degree of anisotropy in the microstructure of the magnetic material by application of an external magnetic field, particularly during the HD step. Each step of the method is separately discussed in more detail below.

First, a starting magnetic material is provided. The starting magnetic material is not particularly limited, but is typically a compound including a rare earth metal component (RE), a transition metal component (TM), and may or may not include a third, nonmetal component (X) such as boron or nitrogen. For example, the starting magnetic material may be a ternary compound and may have one of the following chemical compositions: (RE)₂(TM)₁₄X; (RE)(TM)₅; (RE)₂(TM)₁₇; (RE)₅(TM)₁₇; (RE)(TM)₂; (RE)(TM)₃; (RE)₆(TM)₂₃; (RE)₂(TM)₇; (RE)₅(TM)₁₉; (RE)(TM)₁₂; (RE)₃(TM)₂₇; (RE)(TM)₄X; (RE)(TM)₁₂X₆; (RE)₂(TM)₂₃X₃; (RE)₅(TM)₉X; (RE)₂(TM)₅X₂; (RE)₂(TM)₇X₃; (RE)₂(TM)₁₇X₃; (RE)₃(TM)₁₁X₄; (RE)₃(TM)₁₃X₂, (RE)₅(TM)₁₉X₆. In other embodiments, the starting magnetic material may have the chemical formula Nd₂₋ₓ(RE)ₓFe_{14-y}(TM)_{y}B, wherein: RE is one of La, Ce, Pr, Sm, Gd, Tb, Dy, Ho, Er, Tm, Yb, Lu, Th, and Y; TM is one of Fe and Co; 0≤x≤2; and 0≤y≤14. The transition metal may also include Ga. In one exemplary embodiment, the starting magnetic material is Nd₂Fe₁₄B.

Next, the starting material is placed in an inert atmosphere and subjected to a hydrogenation-disproportionation (HD) step in the presence of an applied static magnetic field. The HD step includes heating the starting magnetic material to a first temperature and introducing a concentration of hydrogen gas to the starting magnetic material for a first period of time to obtain intermediate materials (constituent elemental and binary products and often also hydrides). In the case of Nd₂Fe₁₄B, the intermediate materials include NdH₂₋ₓ, Fe, and Fe₂B. The strength of the magnetic field is set between 0.25 T and 9 T, such as 1 T, 1.5 T, 2 T, 3 T, 4 T, 5 T, 6 T, 7 T, 8 T, or 9 T, but is preferably less than or equal to 2 T, optionally 1.9 T±0.05 T, optionally 1.8 T±0.05 T, optionally 1.7 T±0.05 T, optionally 1.6 T±0.05 T, optionally 1.5 T±0.05 T, optionally 1.4 T±0.05 T, optionally 1.3 T±0.05 T, optionally 1.2 T±0.05 T, optionally 1.1 T±0.05 T, optionally 1.0 T±0.05 T, optionally 0.9 T±0.05 T, optionally 0.8 T±0.05 T, optionally 0.7 T±0.05 T, optionally 0.6 T±0.05 T, optionally 0.5 T±0.05 T, optionally 0.4 T±0.05 T, optionally 0.3 T±0.05 T, optionally 0.25 T±0.05 T. The first temperature is at least 600° C., optionally at least 630° C., optionally at least 650° C., optionally at least 675° C., optionally at least 700° C., optionally at least 725° C., optionally at least 750° C., optionally at least 775° C., optionally at least 800° C., and further may be in the range of 600° C. to 900° C., optionally 600° C.±5° C., optionally 610° C.±5° C., optionally 620° C.±5° C., optionally 630° C.±5° C., optionally 640° C.±5° C., optionally 650° C.±5° C., optionally 660° C.±5° C., optionally 670° C.±5° C., optionally 680° C.±5° C., optionally 690° C.±5° C., optionally 700° C.±5° C., optionally 710° C.±5° C., optionally 720° C.±5° C., optionally 730° C.±5° C., optionally 740° C.±5° C., optionally 750° C.±5° C., optionally 760° C.±5° C., optionally 770° C.±5° C., optionally 780° C.±5° C., optionally 790° C.±5° C., optionally 800° C.±5° C., optionally 810° C.±5° C., optionally 820° C.±5° C., optionally 830° C.±5° C., optionally 840° C.±5° C., optionally 850° C.±5° C., optionally 860° C.±5° C., optionally 870° C.±5° C., optionally 880° C.±5° C., optionally 890° C.±5° C., optionally 900° C.±5° C. The first period of time, which is the time period necessary to complete the HD step, is between approximately 10 and 60 minutes, optionally between approximately 10 and 30 minutes, preferably approximately 30 minutes, e.g. 30 minutes±5 minutes, optionally approximately 15 minutes±5 minutes, optionally approximately 20 minutes±5 minutes, optionally approximately 25 minutes±5 minutes, optionally approximately 35 minutes±5 minutes, optionally approximately 40 minutes±5 minutes, optionally approximately 45 minutes±5 minutes, optionally approximately 50 minutes±5 minutes, optionally approximately 55 minutes±5 minutes.

Applying a static magnetic field during the HD step increases the reactivity of the hydrogen gas due to the Zeeman effect on disassociated elemental hydrogen above room temperatures. The Zeeman effect (the splitting of quantum states under application of a magnetic field) causes thermally excited hydrogen electrons to become even more reactive than comparable hydrogen electrons with no magnetic field applied. A corollary effect also induced by the static magnetic field is that the transition metals formed by hydrogen disproportionation (either Fe or Co) are ferromagnetic. This results in the Gibbs free energy of formation of these phases being lower and causes a driving force towards the completion of the disproportionation reaction (that is ultimately time-dependent on the kinetics of the initial gas-solid reaction). Thus, the application of the static magnetic field during the HD step advantageously increases the reaction rate, expediting the disproportionation or “decomposition” of the magnetic material into the three phases described above, and likewise reduces the time the HD step can be performed in by 75% or more. For example, as noted above, the period for the HD step is approximately 30 minutes or less, whereas the time period for the HD step is typically over two hours when the HD step is performed conventionally without a magnetic field. In addition to lower processing time for the HD step, the application of a static magnetic field may lower the processing temperature (i.e., the first temperature) and/or the required partial pressure of hydrogen gas. The parameters of the HD step thus include thermal processing parameters including the dwell temperature, the temperature ramp rate, and the dwell time, gas parameters including percent H₂ in supply gas (which may be represented as the hydrogen partial pressure in the supply gas), the total pressure, and the gas introduction temperature, and magnetic field parameters including the applied magnetic field strength.

Once the HD step is complete, the intermediate materials may be allowed to cool to ambient temperature to separate the HD step from the subsequent DR step. The intermediate materials may be actively cooled at a controlled rate by a cooling device, or faster at an uncontrolled, passive, non-linear “furnace cooling.” Alternatively, the DR step can be performed without a cooling step beforehand. In either event, after a prescribed dwell time from completion of the HD step, the DR step is initiated. The DR step includes switching the gas environment surrounding the intermediate materials by using a vacuum pump or by flushing the hydrogen with a noble gas. This can be done while the gas is cool (if cooling was performed after the HD step) or while the gas remains hot, if no cooling was performed. In either case, after the hydrogen gas is removed, the intermediate materials are either heated to a second temperature and/or maintained/held at the second temperature for a second period of time under vacuum to obtain a magnetic powder. The second temperature may be approximately the same as the first temperature, or alternatively may be greater than the first temperature. In various embodiments, the second temperature is at least 600° C., optionally at least 630° C., optionally at least 650° C., optionally at least 675° C., optionally at least 700° C., optionally at least 725° C., optionally at least 750° C., optionally at least 775° C., optionally at least 800° C., and further may be in the range of 600° C. to 900° C., optionally 600° C.±5° C., optionally 610° C.±5° C., optionally 620° C.±5° C., optionally 630° C.±5° C., optionally 640° C.±5° C., optionally 650° C.±5° C., optionally 660° C.±5° C., optionally 670° C.±5° C., optionally 680° C.±5° C., optionally 690° C.±5° C., optionally 700° C.±5° C., optionally 710° C.±5° C., optionally 720° C.±5° C., optionally 730° C.±5° C., optionally 740° C.±5° C., optionally 750° C.±5° C., optionally 760° C.±5° C., optionally 770° C.±5° C., optionally 780° C.±5° C., optionally 790° C.±5° C., optionally 800° C.±5° C., optionally 810° C.±5° C., optionally 820° C.±5° C., optionally 830° C.±5° C., optionally 840° C.±5° C., optionally 850° C.±5° C., optionally 860° C.±5° C., optionally 870° C.±5° C., optionally 880° C.±5° C., optionally 890° C.±5° C., optionally 900° C.±5° C. The second period of time may be approximately 30 minutes (±5 minutes) or longer, and optionally may be in the range of approximately 30 to 60 minutes. After the second period of time, the obtained magnetic powder is cooled, either at a controlled (active) of uncontrolled (furnace cooled) rate. The parameters of the DR step thus include thermal processing parameters including the dwell temperature, the temperature ramp rate (if any), the dwell time, and the cooling rate, pressure processing parameters including the vacuum pressure, and magnetic field parameters including the applied magnetic field strength (if any).

Application of the static magnetic field during the HD step increases the magnetic anisotropy of the obtained magnetic powder. Thus, the end result of this application of a magnetic field is to alter the microstructure/magnetic properties including the anisotropy of the final material, i.e. the magnetic powder. Optionally, the static magnetic field may also be applied during the DR step. The application of the field during the DR step results in a positive effect on the desired properties through maintenance and promotion of the crystallographic texture, i.e. it maintains magnetic texturing effects.

### EXAMPLES

The present method is further described in connection with the following laboratory examples, which are intended to be non-limiting.

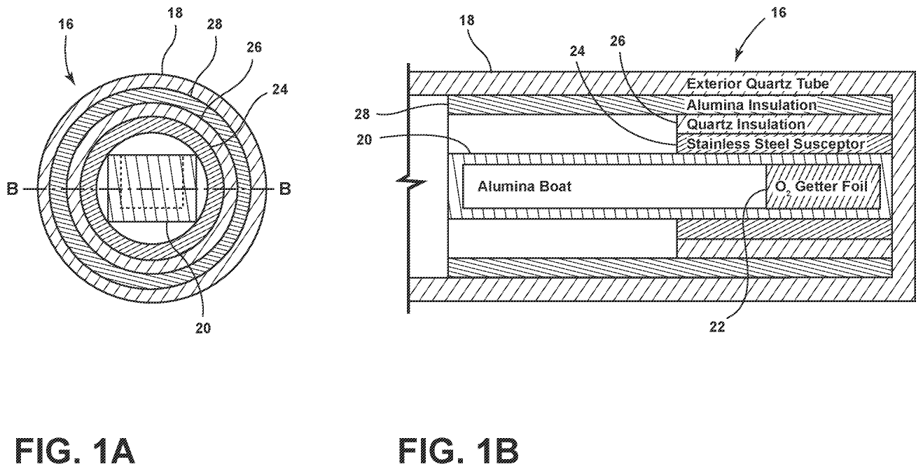

With reference to FIGS. 1A, 1B. and 2, an apparatus 10 for implementing the present HDDR process includes a cylindrical superconducting cryo-magnet 12 that has a concentric bore 14 and is the static magnetic field applying device. Alternatively, the apparatus could include resistive electromagnets or permanent magnets as the magnetic field applying source. Inside the bore 14, a copper shield is inserted as a “secondary insert” to protect the superconducting magnet from any generated heat, before a “primary insert” formed of an induction coil is slotted inside, positioned so that the coil sits within the uniform-magnetic-flux range in the center of the magnet 12. This coil is used as the source of heating during the HDDR process, but resistive heating or other convective or radiating heating sources could be applied as well. A reaction vessel 16 is placed concentrically within the primary insert. The reaction vessel 16 is defined in part by a quartz tube 18, hermetically sealed to an elbow-style gate valve. Within the quartz tube, the sample (starting magnetic material) is placed inside of folded oxygen gettering foil, which rests within an alumina boat 20 along with another oxygen gettering foil 22. The boat 20 is placed within a steel, cylindrical tube-shaped susceptor (heating element) 24, which is radially insulated from the quartz walls of the reaction vessel by a slightly larger diameter quartz tube 26 (compared to the susceptor). This quartz tube 26 is itself placed inside of an alumina tube 28, completing the radial insulation as shown schematically in FIGS. 1A-B. For accurate temperature control, one thermocouple is placed in proximity to the sample wrapped in the oxygen gettering foil, while another is placed between the insulating alumina tube 28 and the quartz wall 18 of the reaction vessel 16.

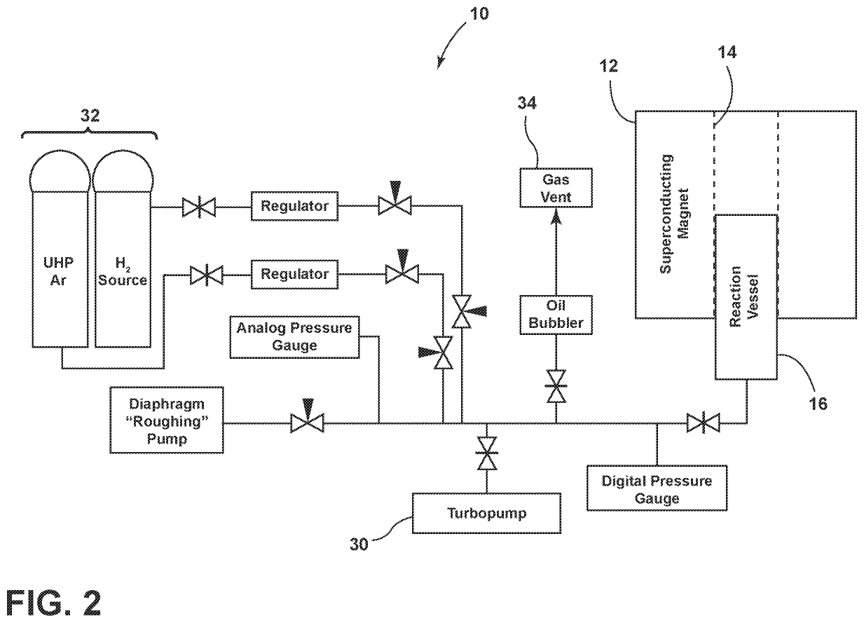

The aforementioned elbow valve is connected to a vacuum source 30, a (hydrogen) gas supply 32, and an outlet for overpressure 34, as shown schematically in FIG. 2. In the HD step, the vacuum sucks from the interior of the reaction vessel, removing oxygen from the reaction atmosphere. Afterwards, gas containing a specified percentage of hydrogen is supplied from the source 32 to a slight overpressure within the reaction vessel 16. The induction coil is then used to heat the steel susceptor 24, thus heating the sample to the reaction temperature and holding temperature for an amount of time. At this point, two separate methodologies are possible. The sample can be cooled at a controlled rate by the induction coil, or by turning off the induction coil current for quick but non-linear, “furnace cooling” of the sample. The DR step involves switching the gas environment as much as possible using the vacuum pump 30. This can be done while the gas is cool or while the gas remains hot from the HD step. In either case, after the gas is removed, the sample is then heated while under active vacuum to the DR processing temperature. The sample is held at that processing temperature for a predetermined amount of time, before it is allowed to cool at either a controlled or uncontrolled (furnace cooled) rate.

Alloys with nominal composition of Nd₁₄Fe₈₁B₇ were arc-melted and drop casted into a cylinder-shaped ingot with a diameter of 12 mm. The sample was annealed in an inert environment (sealed in a quartz tube under an Ar pressure of ¼ atm) at 1293 K for 120 hours. Powder X-ray diffraction showed only peaks of Nd₂Fe₁₄B. The very small number of Nd-rich phases or α-Fe were buried in X-ray scattering background. These secondary phases were observed in SEM.

The reaction chamber/vessel 16 as shown in FIGS. 1A-B was used. Prior to processing, the surface layer of the original sample was ground away with a belt sander, and sectioned using a low-speed diamond saw into 1 mm thick, 10 mm diameter discs. These discs were ground with fine-grit sandpaper, cleaned with absolute ethanol, broken in half into semicircle shapes, wrapped in tantalum foil, and placed at the end of the alumina boat 20. Zr foil was added to the boat as an oxygen getter, and a thermocouple was attached to the boat with 90% nickel, 10% chromium alloy wire, as close to the sample piece as possible without contact.

The alumina boat 20 was placed such that the sample was concentric within the stainless steel susceptor 24 (as discussed above, the susceptor rather than the sample itself is heated by the induction coil). The susceptor was insulated via the first, slightly larger diameter quartz tube 26, followed by the alumina tube 28. The additional thermocouple was loaded to measure the temperature on the outside of this insulating alumina, to prevent possible temperature runaway and experiment failure.

This arrangement was loaded into the custom-built reaction vessel 16 formed of a 2-inch diameter quartz tube sealed to a quick-fit flange. This flange was sealed to a commercially available elbow valve, with vacuum tight feedthroughs for thermocouple connections. The entirety of the reaction vessel 16 rested within the inner bore 14 of the insert containing a copper induction coil, which itself was centered within the bore of an American Magnetics 9 Tesla superconducting magnet 12. This allowed for material processing from ambient conditions to applied fields up to 9 T.

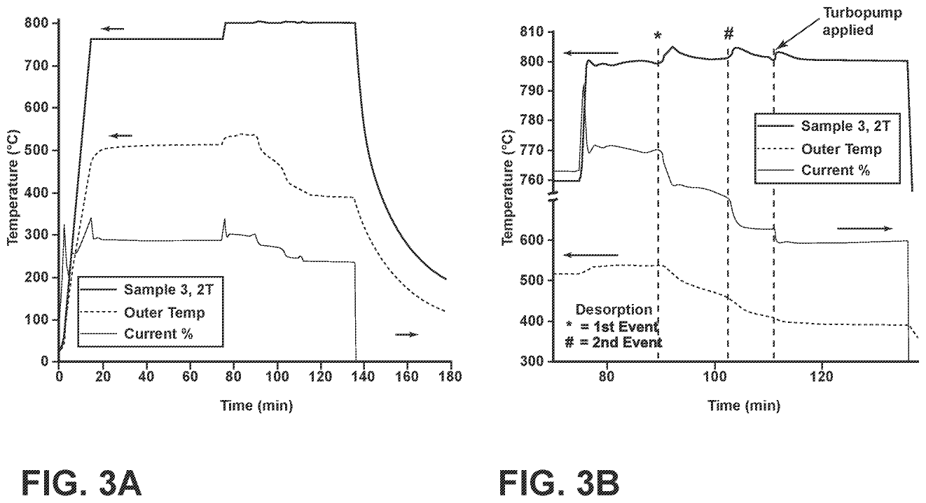

The processing procedure for the test sample followed a “dynamic” HDDR methodology (“dynamic” indicating the gas was slowly removed during the DR step). The heating profile for the process is shown in FIGS. 3A and 3B. The samples first underwent the hydrogenation-disproportionation (HD) step, which consisted of evacuating the reaction vessel to ˜10 mTorr, then introducing the hydrogen supply gas at an overpressure connected to an oil bubbler (at flow rate of approximately 0.5 cc/s). The supply gas consisted of 30% H₂ balanced with Ar. The stainless steel susceptor was directly induction heated by the induction coil, and the samples were consequently heated by the stainless steel susceptor via convection and/or radiative heating. The samples were heated in the presence of the hydrogen supply gas at 50° C./min to 760° C., and held at that temperature for an hour. The temperature ramp rate is such that the samples were not entirely decrepitated prior to disproportionation, as evidenced by their morphology after the HDDR process was complete. The sample morphology (post-HDDR) generally looked as if the initial semicircle-shaped samples had been broken into three or four large fractions, each of which could be easily ground into powder with mortar and pestle.

The desorption-recombination (DR) step began with a temperature ramp from 760° C. to 800° C. (<1 minute). The reaction vessel was isolated from the gas inlet and outlet, and a needle valve on a rotary vacuum pump was slowly opened to reduce the hydrogen pressure in the reaction vessel at a slow rate over 30 minutes. The rate was estimated by attempting to keep the measured temperature constant while the convection heating medium (the gas) was removed. During this process, two features were visible in the measured temperature data, corresponding to the completion of two separate desorption events. At the end of the 30 minutes, the vacuum pump needle valve was closed at approximately 500 mTorr and a stronger vacuum was applied via a spun-up turbopump. The application of this vacuum and the removal of the remaining heat transfer media resulted in the third feature in the measured profile as shown in FIG. 3B. This vacuum was applied for an additional 30 minutes, with a resulting pressure of approximately 10 mTorr. At this time, the induction coil current was turned off, and the samples were then allowed to furnace cool in the vacuum environment until it reached room temperature.

The reaction vessel was then sealed off using the gate valve and placed in a helium-filled glovebox for further sample handling and storage. Portions of the samples (notably still solid and sometimes cracked, but essentially monolithic) were crushed in the helium glovebox and characterized via powder X-ray diffraction (PXRD) in air. Samples processed in a 2 T magnetic field were noticeably more difficult to handle, as the crushed powder was magnetized and attracted to itself. PXRD was performed with a Panalytical X'Pert Pro diffractometer using a Cu Kα source, and the resulting data was analyzed via the HighScorePlus software package.

Upon verification of Nd₂Fe₁₄B phase formation, portions of the samples were crushed, and a small mass (˜5 mg) was mixed in paraffin wax and measured in a Quantum Design MPMS XL SQUID magnetometer. Magnetometry measurements were performed by heating the samples and wax to above the wax melting point (˜320 K) in zero applied magnetic field to suspend the sample in the wax, then cooling to 300 K. The applied field was then raised to +5 T, and a hysteresis loop was performed to −5 T and back to obtain the “unaligned” magnetization loop. To measure the magnetically aligned properties, while the magnetometer was at +5 T, the sample was again heated to 320 K to melt the wax and allow powder particles to reorient in response to the field. The wax was then solidified by cooling to 300 K, and an additional “aligned” magnetization loop was measured.

Both the HD and DR steps above were performed either consistently without an applied field (i.e., 0 T) or with an applied field of 2 Tesla (i.e., 2 T). Diffraction patterns of the resultant samples showed little to no consistent dependence on the application of a 2 T field. In both the 0 T and 2 T cases, the phases produced include primarily the Nd₂Fe₁₄B phase, with minor inclusions of a cubic Nd oxide (fcc-NdOₓ) and Fe. Rietveld refinement on the resulting patterns indicated that the phase fraction of fcc-NdOₓ ranges from −5.4 to 9.3 wt. % of the final product, regardless of the applied magnetic field. The presence of these phases in the final product is consistent with a leak, or otherwise adsorbed oxygen in the reaction apparatus. Though the presence of this phase undoubtedly affected the resultant magnetic properties, the coercivity values nevertheless remained fairly consistent.

Williamson-Hall plots were used to estimate the crystallite size produced from the dynamic-HDDR methodology utilized for the test samples. Further, the 0 T and 2 T samples were comparted to determine whether the application of a magnetic field had a reliable effect on the resulting grain size. In most of the samples, the minimum grain size fell within the range of 70-90 nm, suggesting the processing method resulted in particle sizes smaller than a single magnetic domain regardless of applied field. Additionally, the field did not result in grain sizes outside the range of sizes seen in samples processed at ambient field when characterized using this method.

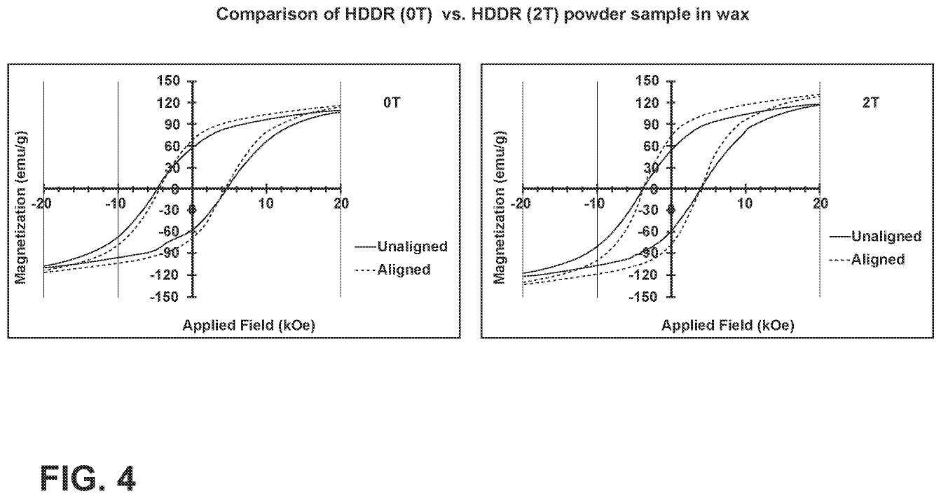

The presence or absence of an applied magnetic field during the HDDR process had minor consequences on the ultimate phase formation and average grain size. However, the field had a greater effect on the magnetic properties of the resultant material, indicating a degree of microstructural dependence. Samples processed at 0 T and 2 T had differences between the magnetization saturation of the aligned and unaligned loops as shown in FIG. 4, indicating the HDDR heating profile and reaction apparatus maintained some amount of crystallographic anisotropy in the material from its pre-processing character.

The application of a 2 T magnetic field during HDDR processing resulted in a material with greater remanence and magnetic saturation, but lower coercivity than that of the 0 T samples. However, the application of the 2 T magnetic field during processing also enhanced the magnetic anisotropy of the sample. This is difficult to quantify by the “degree of alignment” (DOA) metric, but it is apparent in the “ratio of remanence to saturation” (M_{R}/Mₛₐₜ) metric. The DOA metric is a comparison of the magnetic response of the powder when it is unaligned, or randomized, compared to when it is ordered through magnetic alignment. One way to quantify this using magnetization data is the following equation:

$$D . O . A . = 2 ( {M}_{R , aligned} - {M}_{R , unaligned} ) / ( {M}_{R , aligned} ) \qquad ( 1 )$$

This metric is useful for conventionally processed samples, as well as for the samples processed at 0 T. However, the application of the 2 T processing magnetic field and the resulting magnetization of the product causes the M_{R,unaligned} value to be misrepresented in this equation, as the unaligned magnetic remanence will not represent a true randomness of orientation of the powder. While heating the magnetized powder above its Curie temperature would remove this complication, it also resulted in the degradation and oxidation of the product. Thus, it is expected that the value of the DOA for the 2 T samples would underestimate this quantity to a varying degree based on sample selection.

An additional way to quantify the magnetic anisotropy of the system is the value of the M_{R}/Mₛₐₜ ratio. When quantified for the “aligned” magnetization loops, this quantity indicates how the alignment of particles along their easy magnetization axis causes the material to retain its magnetization as the applied field is reduced to zero. For a randomly oriented sample of hard magnetic crystallites that do not exhibit magnetic exchange (“decoupled”), M_{R}/Mₛₐₜ=0.5. It is the exchange coupling of hard nano-sized crystallites that leads to the “remanence enhancement” effect, which causes M_{R}/Mₛₐₜ to be greater than 0.5. It should be noted that in these characterizations, the highest applied field in the magnetometer is 5 T, which is not expected to fully saturate the material (though we continue to use the Mₛₐₜ notation); however, this should similarly cause an underestimation of the ratio in both “aligned” loops at 0 T and 2 T, allowing for a comparison between them, if not an absolute value.

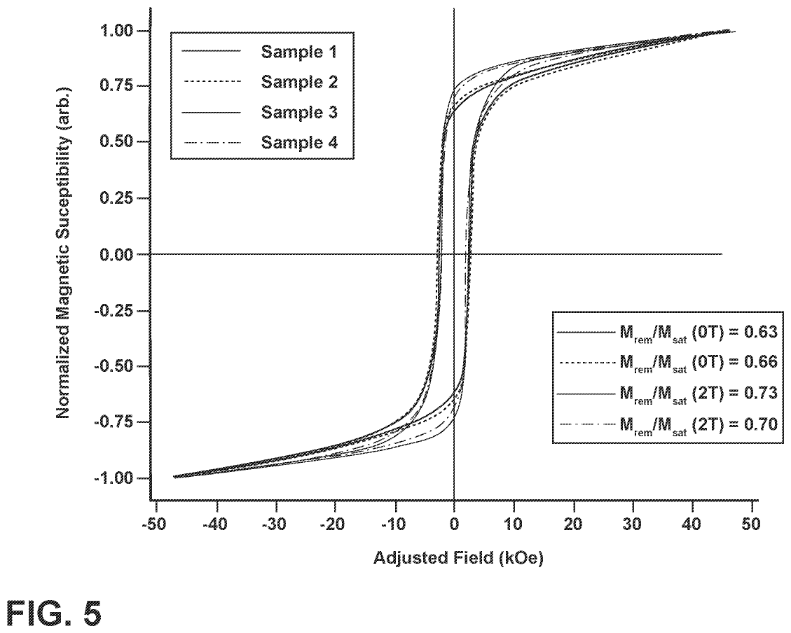

In the case of the aligned loop of the 0 T processed sample, the M_{R}/Mₛₐₜ ratio value ranged from 0.63-0.66, while the ratio in the 2 T aligned loop ranged from 0.70-0.73. This comparison is more easily observed when the M vs. H loops are normalized to their Mₛₐₜ value, as shown in FIG. 5. Using this metric, the application of the field during HD and DR processing notably enhanced the anisotropy of the resulting material.

The magnetic data was non-uniformly scaled utilizing geometric demagnetization factors of 0.22 and 0.33. The use of the 0.33 value is equivalent to treating the shape of the powder particle as a sphere; however, when this resulted in non-physical behavior of the M vs. H loops, the demagnetization factor was reduced. It was found for samples with non-physical behavior that the demagnetization factor of 0.22 could be uniformly applied to produce more recognizably physical M vs. H curves (This also indicates that the shape of the produced Nd₂Fe₁₄B particles may vary between samples). The significance of the demagnetization factor can be seen through the following equation:

$$H = {H}_{appl} ( N * M ) \qquad ( 2 )$$

where H is the scaled field, Hₐₚₚₗ is the applied field, N is the demagnetization factor, and M is the powder magnetization. Determining N has been explored for several three-dimensional geometries useful for single crystal measurements, but for a powder it can be shown specifically for a sample of spherical particles that:

$$N = ( 1 / 3 ) + f ( {D}_{z} - ( 1 / 3 ) ) \qquad ( 3 )$$

where D_{z} is the demagnetization factor due to the shape of the packing of the powder (NOT the particles within, which as stated are assumed to be spherical), and f is the packing fraction of the powder.

A D_{z} of ⅓ (as if the powder packing was spherical) would result in N=⅓, as would a low packing density of the powder where the particulates do not interact magnetically. The latter is unlikely to be the case with Nd₂Fe₁₄B due to the material's large internal magnetic field. Determination of the demagnetization factor of a powder sample is therefore difficult to ascertain experimentally, requiring both a controlled geometric packing of the powder into a specific shape, as well as reducing any geometric variance of the powder itself to “spheres.” The packing shape of the powder was not strictly controlled in the present characterization. However, the powder was loaded into cylindrical sample holders, giving some hint as to a possible value of D_{z} (0.11, for solid cylinders). In this case, the values of N vary between −0.33 to −0.11 linearly with f. At this point, with an indeterminable value of f, the effect of both the minimum (0.11) and maximum (0.33) demagnetization factors may be considered as reasonable bounds on the actual magnetic behavior of the samples. So long as the hysteresis loop remains physical (that is, approaching a square-shaped loop as opposed to an “S” shaped loop), the larger demagnetization factor results in magnetic property values of greater magnitude than smaller values of N. Therefore, the magnetic property values are presented below based on N=0.22 and 0.33.

TABLE 1
Relevant magnetic property values of samples 1-4

| | | | | Magnetic | Magnetic | | | Maximum |
|---|---|---|---|---|---|---|---|---|
| | Processing | Demagnetization | | Saturation at | Remanence | Aligned | Coercivity | Energy |
| # | Field (T) | Factor | Alignment | 5 T (emu/g) | (emu/g) | M_{R}/Mₛₐₜ | (kOe) | Product |
| 1 | 0 | 0.33 | Unaligned | 122 | 62 | — | 2.5 | — |
| | | | Aligned | 125 | 79 | 0.63 | | 7.0 |
| 2 | 0 | 0.22 | Unaligned | 149 | 72 | — | 3.4 | — |
| | | | Aligned | 155 | 104 | 0.67 | | 10.5 |
| 3 | 2 | 0.22 | Unaligned | 137 | 79 | — | 2.3 | — |
| | | | Aligned | 139 | 102 | 0.73 | | 8.7 |
| 4 | 2 | 0.33 | Unaligned | 145 | 87 | — | 2 | — |
| | | | Aligned | 148 | 104 | 0.70 | | 8.6 |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of increasing anisotropy of magnetic materials formed by a hydrogenation-disproportionation-desorption-recombination (HDDR) process, the method comprising:
providing a starting magnetic material;
subjecting the starting magnetic material to a hydrogenation-disproportionation (HD) step in the presence of a magnetic field to obtain intermediate materials; and
subsequently subjecting the intermediate materials to a desorption-recombination (DR) step to obtain a magnetic powder;
whereby application of the magnetic field during the hydrogenation-disproportionation step increases the magnetic anisotropy of the obtained magnetic powder.

2. The method of claim 1, wherein the strength of the applied magnetic field is between 0.25 T and 9 T.

3. The method of claim 2, wherein the strength of the applied magnetic field is less than or equal to 2 T.

4. The method of claim 1, wherein the hydrogenation-disproportionation step is performed for a period of time between approximately 10 and 60 minutes.

5. The method of claim 1, wherein the hydrogenation-disproportionation step includes heating the starting magnetic material to a temperature of at least 600° C. in the presence of hydrogen gas.

6. The method of claim 5, wherein the temperature is in a range of 600° C. to 900° C.

7. The method of claim 1, wherein the magnetic field is also applied during the desorption-recombination step.

8. The method of claim 1, wherein the starting magnetic material is a compound including one of the following chemical compositions: (RE)₂(TM)₁₄X; (RE)(TM)₅; (RE)₂(TM)₁₇; (RE)₅(TM)₁₇; (RE)(TM)₂; (RE)(TM)₃; (RE)₆(TM)₂₃; (RE)₂(TM)₇; (RE)₅(TM)₁₉; (RE)(TM)₁₂; (RE)₃(TM)₂₇; (RE)(TM)₄X; (RE)(TM)₁₂X₆; (RE)₂(TM)₂₃X₃; (RE)₅(TM)₉X; (RE)₂(TM)₅X₂; (RE)₂(TM)₇X₃; (RE)₂(TM)₁₇X₃; (RE)₃(TM)₁₁X₄; (RE)₃(TM)₁₃X₂, (RE)₅(TM)₁₉X₆; wherein RE is a rare earth metal component, TM is a transition metal component, and X is a nonmetal component including boron or nitrogen.

9. A method of increasing anisotropy of magnetic materials formed by a hydrogenation-disproportionation-desorption-recombination (HDDR) process, the method comprising:
providing a starting magnetic material;
disposing the starting magnetic material in an inert atmosphere;
subjecting the starting magnetic material to a hydrogenation-disproportionation (HD) step in the presence of an applied static magnetic field, the hydrogenation-disproportionation step including:
heating the starting magnetic material to a first temperature and introducing a concentration of hydrogen gas to the starting magnetic material for a first period of time to obtain intermediate materials; and
subsequently subjecting the intermediate materials to a desorption-recombination (DR) step, the desorption-recombination step including:
purging the hydrogen gas, heating the intermediate materials to a second temperature under vacuum, maintaining the second temperature for a second period of time under vacuum to obtain a magnetic powder, and allowing the magnetic powder to cool;
whereby application of the static magnetic field during the hydrogenation-disproportionation step increases the magnetic anisotropy of the obtained magnetic powder.

10. The method of claim 9, wherein the strength of the applied magnetic field is between 0.25 T and 9 T.

11. The method of claim 10, wherein the strength of the applied magnetic field is less than or equal to 2 T.

12. The method of claim 9, wherein the desorption-recombination step further includes applying the static magnetic field.

13. The method of claim 9, wherein the first temperature is in a range of 600° C. to 900° C.

14. The method of claim 9, wherein the first period of time is in a range of 10 to 60 minutes.

15. The method of claim 9, wherein the second temperature is approximately equal to or greater than the first temperature.

16. The method of claim 9, wherein the second period of time is at least 30 minutes.

17. The method of claim 9, wherein prior to the desorption-recombination step, the intermediate materials obtained in the hydrogenation-disproportionation step are cooled to ambient temperature.

18. The method of claim 9, wherein the starting magnetic material is a compound including one of the following chemical compositions: (RE)₂(TM)₁₄X; (RE)(TM)₅; (RE)₂(TM)₁₇; (RE)₅(TM)₁₇; (RE)(TM)₂; (RE)(TM)₃; (RE)₆(TM)₂₃; (RE)₂(TM)₇; (RE)₅(TM)₁₉; (RE)(TM)₁₂; (RE)₃(TM)₂₇; (RE)(TM)₄X; (RE)(TM)₁₂X₆; (RE)₂(TM)₂₃X₃; (RE)₅(TM)₉X; (RE)₂(TM)₅X₂; (RE)₂(TM)₇X₃; (RE)₂(TM)₁₇X₃; (RE)₃(TM)₁₁X₄; (RE)₃(TM)₁₃X₂, (RE)₅(TM)₁₉X₆; wherein RE is a rare earth metal component, TM is a transition metal component, and X is a nonmetal component including boron or nitrogen.

19. The method of claim 9, wherein the starting magnetic material is a compound including both a rare earth metal component (RE) and a transition metal component (TM), the starting magnetic material having the chemical formula Nd₂₋ₓ(RE)ₓFe_{14-y}(TM)_{y}B, wherein: RE is one of La, Ce, Pr, Sm, Gd, Tb, Dy, Ho, Er, Tm, Yb, Lu, Th, and Y; TM is one of Fe and Co; 0≤x≤2; and 0≤y≤14.

20. The method of claim 19, wherein the starting magnetic material includes Nd₂Fe₁₄B.

21. A magnetic powder obtained by the method of claim 1.

22. A magnetic powder obtained by the method of claim 9.

23. A magnet formed with the magnetic powder of claim 21, wherein the magnet is one of a bonded magnet, a sintered magnet, or a powder-in-tube magnet.

24. A magnet formed with the magnetic powder of claim 22, wherein the magnet is one of a bonded magnet, a sintered magnet, or a powder-in-tube magnet.
